(19) United States
(12) Patent Application Publication
(10) Pub. No.: US 2003/0187738 A1
(43) Pub. Date: Oct. 2, 2003

(54) Individual discount system for optimizing retail store performance

(75) Inventor: Cem M. Baydar, Prospect Heights, IL (US)

Correspondence Address: BRINKS HOFER GILSON & LIONE, P.O. BOX 10395, CHICAGO, IL, 60611, US

(73) Assignee: Accenture Global Services GmbH.

(21) Appl. No.: 10/190,004

(22) Filed: Jul. 3, 2002

Related U.S. Application Data
(60) Provisional application No. 60/369,448, filed on Apr. 1, 2002.

(51) Int. Cl. G06F 17/60

(52) U.S. Cl. 705/14; 705/7; 705/10

(57) ABSTRACT

An individual discount system uses a modified simulated annealing operation to determine the best of all possible solutions for optimizing retail store performance. The modified simulated annealing operation provides individual discounts in response to an objective function, input parameters, and customer models. The objective function is composed of several relative objectives and is a mathematical representation of the retail store strategy for optimizing performance.

### CROSS REFERENCE TO RELATED APPLICATIONS

This application claims priority to U.S. Provisional Patent Application No. 60/369,448 entitled “One-To-One Marketing” and filed Apr. 1, 2002, which is incorporated by reference in its entirety.

This application is related to U.S. patent application Ser. No. ______, entitled “Simulation and Optimization System for Retail Store Performance” filed on the same day as the present application and assigned to the same assignee as the present application.

### FIELD OF THE INVENTION

This invention generally relates to customer marketing systems for retail sales. More particularly, this invention relates to one-to-one marketing systems for providing individual discounts to each customer to optimize a store's performance.

### BACKGROUND OF THE INVENTION

As competition in the retail industry increases, retailers desire to optimize store performance. For sectors that have tighter profit margins and where customer loyalty is dependent on product prices, it is important to understand customer behavior. Grocery retail is one of these sectors.

Many grocery chains offer customer loyalty programs. More than half of all U.S households participate in some type of loyalty card program for grocery shopping. A loyalty card program enables a consumer to obtain product discounts when the “card” is presented at the retail store. However, these loyalty programs apply one or more blanket couponing techniques by giving the same coupons or discounts to all of their subscribers. In these techniques, the information about each individual's shopping behavior generally is underutilized, because data from multiple consumers is aggregated and averaged. These techniques usually assume that most people have similar product and price preferences. However, humans are different. Each individual has his or her own preference of products and price levels.

Other grocery chains offer one-to-one marketing programs that model each customer separately to provide him or her individual coupons that could improve a store's performance. While several one-to-one marketing programs have been proposed, these approaches usually do not optimize the store performance in relation to the discounts. The reason is that the customer shopping behavior models are probabilistic and usually have a search space consisting of at least 30,000 products and 1,000 customers. This search space makes finding optimal discounts for each customer computationally difficult even for high-performance optimization methods. As a consequence, store performance optimization usually remains at the assortment and layout optimization level, where the number of the products as well as their store layout is considered.

One-to-one marketing programs typically are difficult to optimize given the presence of many variables and lack of knowledge regarding the performance and location of the optimal and sub-optimal points in the search space. In addition, some domains may be stochastic by nature, which makes providing optimal solutions a difficult task. Most optimization approaches are very ineffective when computing individual discounts to optimize store performance.

### SUMMARY

This invention provides an individual discount system that uses a modified simulated annealing operation to determine a solution in a set of all possible solutions that has the minimum or maximum value of an object function for optimizing retail store performance. The modified simulated annealing operation provides individual discounts in response to the objective function, input parameters, and customer models. The modified simulated annealing operation has a deterministic selection of initial starting points and/or a weighted relation of next generation starting points.

In a method for optimizing retail store performance with individual discounts, input parameters are selected. A search space is divided in response to the input parameters. Initial starting points are generated in the search space. A random neighbor is selected for such initial starting point. An average fitness of the initial starting points is evaluated. New starting points are generated in response to the average fitness.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 represents a block diagram or flow chart of an individual discount system for providing individual discounts to optimize retail store performance.

FIG. 2 is a flowchart of a method for optimizing retail store performance with individual discounts.

### DETAILED DESCRIPTION OF THE PREFERRED EMBODIMENTS

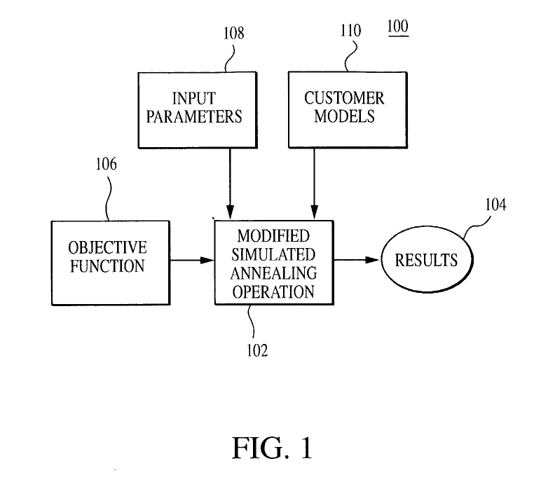

FIG. 1 represents a block diagram or flow chart of an individual discount system 100 for providing individual discounts to optimize retail store performance. In the individual discount system 100, a modified simulated annealing operation 102 provides results 104 in response to an objective function 106, input parameters 108, and customer models 110. While particular configurations are shown and discussed, other configurations may be used including those with fewer or additional components.

The modified simulated annealing operation 102 determines the best of all possible solutions for optimizing retail store performance. The simulated annealing operation is a randomized local search for finding optimal solutions. Modified simulated annealing derives from the roughly analogous physical process of heating and slowly cooling a substance to obtain a crystalline structure. The modified simulated annealing operation 102 finds a solution in the set of all possible solutions that has the minimum or maximum value of the objective function 106. The objective function 106 is a mathematical representation of a retail store strategy. The objective function is associated with a particular optimization objective, such as store performance, that determines how good a result or solution is. After the store strategy or objective function 106 is defined, the modified simulated annealing operation 102 finds a set of individual discounts which satisfy the store strategy.

The objective function 106 is composed of several relative objectives such as profits, sales volume and customer satisfaction. Other objectives may be used. A grocery store manager or other authority decides the store strategy based on the relative importance of these goals or objectives. Some goals are contradictory. For example, a store manager could maximize customer satisfaction by reducing all prices to zero, but that would eliminate any profit. What determines overall store performance is the relative importance of each objective. This relative importance can be defined or set by using a coefficient, a weight, for each objective. For example, an objective function may be the following system:

f(x,y,z)=0.2*x+0.5*y+0.3*z.

The variables x, y and z are the objectives (which can be profits, sales volume and customer satisfaction). The weights for these objectives are 0.2, 0.5 and 0.3. In this example, objective y has the most importance. The total value of all weights is equal to 1.

Input parameters 108 are the numeric values required by the modified simulated annealing operation 102. The input parameters 108 include the number of subpopulations, subpopulation size, starting temperature, temperature reduction rate, and cooling temperature. The input parameters 108 may include other values.

Customer models 110 are the mathematical representations of customers' shopping behavior. There is one model supplied for each customer. A customer model can contain a customer's shopping frequency (i.e., once a week on Saturdays), price sensitivity, consumption rate for each product, preferred product groups, and the like. Several other parameters can also be included in a customer's model to represent his or her shopping behavior accurately. Results 104 are the individual discounts provided by the modified simulated annealing operation 102 to maximize retail store performance based on the supplied objective function 106.

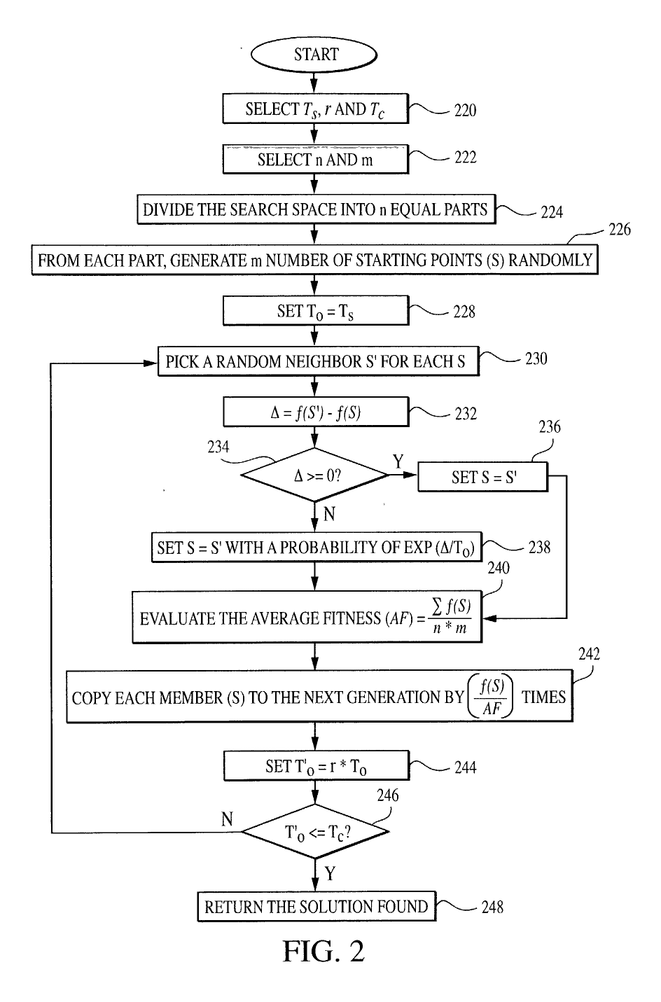

FIG. 2 is a flowchart of a method for optimizing retail store performance 202 with individual discounts. The method provides a modified simulated annealing operation where there is a deterministic selection of starting points and a weighted selection of new starting points with each generation. The deterministic and weighted selections enable the modified simulated annealing operation to determine the individual discounting very efficiently.

The method for optimizing retail store performance 202 finds a maximum value of an objective function, as discussed above. However, the method for optimizing retail store performance may also be modified to find a minimum value of an objective function. At start-up, the starting temperature Tₛ, temperature reduction rate r, and cooling temperature T_{c} are selected 220. The starting temperature Tₛ, temperature reduction rate r, and the cooling temperature T_{c} are selected arbitrarily and control the number of generations or iterations of the modified simulated annealing operation. The use of temperatures or a temperature reduction rate has no relation to physical reality, but in keeping with the modification of a modified simulated annealing operation, allows a user to determine the number of iterations or the length of a “run” of the modified simulated annealing operation. With each iteration as discussed further below, the temperature reduction rate r reduces the starting temperature Tₛ or successive temperature values. The modified simulated annealing operation stops when the temperature is equal to or less than the cooling temperature T_{c}.

The number of subpopulations and the subpopulation size m are selected 222. The search space is divided 224 into n equal parts. The total number of starting points S will be n*m. The search space for an algorithm for a retail store may have up to 50,000 products and 5,000 customers. From each partition of the search space, m number of starting points S are randomly generated 226. This deterministic selection of the initial starting points enables all parts of the search space to be explored.

The operating temperature T₀ is set 228 to the starting temperature T_{S}. A random neighbor S′ is picked 230 for each starting point S. A random neighbor S′ is a point in the partition of the search space adjacent to the starting point S in that partition. For example, points (1,0) and (1,1) are neighbors.

The difference Δ between the objective function f₍ₓ₎ as applied to the random neighbor S′ and as applied to the starting point S is calculated 232 as follows:

Δ=f(S′)−f(S).

For a maximizing function, a difference value greater than zero means that a particular solution in a particular iteration is approaching the goal set by the objective function, while a difference less than zero means that the particular solution does not approach the goal set by the objective function. For a minimizing function, the opposite is true.

The difference Δ is compared 234 to zero. If the difference is greater than or equal to zero, then the starting point S is set 236 to random neighbor S′. If the difference is less than zero, then the starting point S is set 238 to random neighbor S′ with a probability of exp (Δ/T₀).

The average fitness AF of the whole population is evaluated 240. The average fitness AF is an average of the objective function f(x) as applied to each of the starting points, an average f(s) value of the whole population. The average fitness AF is determined by calculating the objective function as applied to each starting point f(s) and dividing the summation of all the objective functions by the total number of starting points as represented by the following equation:

$$AF = \frac{Σ f ( s )}{n * m}$$

Each starting point S is copied 242 to the next generation or iteration in response to the relation between the objective function as applied to the starting point f(s) and the average fitness AF. Each starting point is copied

$$[ \frac{f ( s )}{AF} ]$$

times to the next generation. The value of

$$[ \frac{f ( s )}{AF} ] ,$$

a real number, is rounded-up, rounded-down, or may be rounded-up in one instance and rounded-down in another instance, to an integer. The weighted selection of the next generation of starting points would then eliminate starting points having fitness values f(s) below the average fitness AF, replacing these points with starting points having fitness values above the average fitness AF. The convergence for an optimal solution is obtained more quickly since more promising regions of the search space are explored as points having a fitness value below the average are replaced with more promising points.

The operating temperature T₀ is adjusted 244 by the temperature reduction rate r. The new operating temperature T₀′ is set to equal the previous operating temperature T₀ times the temperature reduction rate r. The new operating temperature T₀′ is compared 246 to the cooling temperature T_{c}. If the new operating temperature T₀′ is greater than the cooling temperature T_{c}, a new random neighbor S′ is picked 230 for each starting point S and the modified simulated annealing operation continues. If the new operating temperature T₀′ is less than or equal to the cooling temperature T_{c}, then the solution is returned 248.

### EXAMPLE

A standard modified simulated annealing operation to illustrate the general principle of the method is illustrated. This example has four iterations. Even though the “temperature” and “temperature reduction rate” have no physical reality, the method uses them to control the number of iterations and the length of a particular operation. This example does not utilize the average fitness or weights discussed above.

The objective is to maximize f(x, y, z)=2*x−3*y+z², in which

xε[0,3]

yε[0,3]

zε[0,3]

Tₛ=10; T_{c}=1; r=0.5.

First Iteration or Generation

T₀=10

Starting point S=(1, 1,1 )

f(S)=2*(1)−3 (1)+(1)²

f(S)=0

random neighbor S′=(1, 2, 0)

f(S′)=2*(1)−3(2)+(0)²

f(S′)=−4

Δ=f(S′)−f(S)

Δ=4−0

Δ=−4<=0

Probability: exp (−4/10)=0.67

The random number sampled from the [0, 1] interval is 0.43

0.43<0.67 then change the point S with S′

S=(1, 2, 0), f(S′)=−4

T₀=10*0.5

T₀=5

Second Iteration or Generation

T₀=5

S=(1,2,0)

random neighbor S′=(2, 1, 1)

f(S′)=2*(2)−3(1)+(1)²

f(S′)=2

Δ=f(S′)−f(S)

Δ=2−(−4)

Δ=6>0

Since Δ>0 take (2, 1, 1) as the new S

S=(2,1,1)

T₀5*0.5

T₀=2.5

Third Iteration or Generation

T₀=2.5

S=(2,1,1)

random neighbor S′=(3, 0, 1)

f(S′)=2*(3)−3(0)+(1)²

f(S′)=7

Δ=f(S′)−f(S)

Δ=7−(2)

Δ=5>0

Since Δ>0take(3, 0, 1) as the new S

S=(3, 0, 1)

T₀=2.5*0.5

T₀=1.25

Fourth Iteration

T₀=1.25

S=(3, 0, 1)

random neighbor S′=(3, 1, 2)

f(S′)=2*(3)−3(1)+(2)²

f(S′)=7

Δ=f(S′)−f(S)

Δ=7−(7)

Δ=0

Probability: exp (−0/1.25)=1

The random number sampled from the [0, 1] interval is 0.8

0.8<1 so select a random neighbor

S=(3, 1, 2), f(S)=7

T₀′=1.25*0.5

T₀=0.625<T_{c}

Return Solution Found

STOP

While the preceding example depicts a standard modified simulated annealing operation, one embodiment of a modified simulated annealing operation selects a plurality of starting points in order to search the search space more efficiently. The modified method works in the following manner. A plurality of points is selected, the selection being made in a random or in a deterministic manner. By deterministic is meant that there is a particular method or formula used to pick the points, e.g. the central point in each of the n parts of the search space, or the point whose added coordinates form the smallest sum, or the point whose added coordinates form the largest sum. Other deterministic formulae or criteria may be used.

For each point selected, also select a random neighbor, a neighbor defined as differing by not more than 1 integer in each dimension of the search space. Evaluate Δ, and based on whether Δ is less than zero, or greater than or equal to zero, pick the point or its nearest neighbor. Then evaluate AF, the average fitness as defined above. Based on the average fitness, copy or map points to the next iteration. The “average fitness” is the sum of the objective function for each point divided by the number of points. Each starting point is copied to the next generation by its f(s) (objective function) divided by the AF. As stated above, this value may be rounded up, rounded down, or sometimes rounded up and sometimes rounded down. Points having a function value less than the average are not copied to the next iteration. Thus, the convergence to an optimal solution is achieved.

In addition to retail store performance, the modified simulated annealing operation may be applied to stock portfolio selection. With a limited amount of money, there are specific numbers of stocks and bonds that can be bought. Each stock and bond has a risk factor and an expected return for a specified period of time. The decision functions on risk taken and expected return can be formulated as:

Maximize f(x)=x

Minimize f(y)=y

where

x is the overall expected return of the invested stocks and/or bonds and

y is the overall risk factor associated with these stocks and/or bonds

The decision is focused on which stocks and/or bonds to buy and what amount should be invested in each stock and/or bond.

The modified simulated annealing operation could provide an optimal solution by identifying the stocks and bonds and the amount of spending that will give the maximum return and minimum risk. Several starting points are generated. Each point represents a combined set of stocks and bonds and the amount of spending on each stock and bond. Then using the modified simulated annealing operation previously described, the optimal selection of bonds and stocks and the amount of spending needed can be found.

Optimal Design of a Factory Floor:

In a similar manner, the modified simulated annealing operation may be applied to the design of a factory floor. To design a factory floor with a specified number of machines, each machine has a specification based on the time required to produce a specific part and the cost of the machine. The objective is to determine the combination of machines to use that minimizes spending and the overall time required to produce parts. The objective function is:

Minimize f(x, y)=x+y

where

x is the overall time spent on producing products, and

y is the overall spending on the machines used.

A modified simulated annealing operation can provide the combination of machines that will provide an optimal design. Several starting points are selected in the decision space. Each point represents a set of machines. Then using the modified simulated annealing operation, the optimum configuration of the factory floor is determined.

Of course, in using a modified simulated annealing operation for optimizing performance of a store, the variables in the objective function will be those associated with coupons, pricing, price sensitivity, customer satisfaction, sales, profits, profit margins, and the like. Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. An individual discount system for optimizing retail store performance, comprising:
a modified simulated annealing operation for providing individual discounts in response to an objective function, at least one input parameter, and at least one customer model,
where the modified simulated annealing operation has a deterministic selection of initial starting points, and
where the modified simulated annealing operation has a weighted selection of next generation starting points.

2. The individual discount system according to claim 1, where the objective function comprises at least one relative objective.

3. The individual discount system according to claim 2, where the at least one relative objective comprises at least one of the profits, sales volume, and customer satisfaction.

4. The individual discount system according to claim 1, where the at least one input parameter comprises at least one of a number of subpopulations, a subpopulation size, a starting temperature, a temperature reduction rate, and a cooling temperature.

5. The individual discount system according to claim 1, where the at least one customer model comprises one model for each customer.

6. An individual discount system for optimizing retail store performance, comprising:
a modified simulated annealing operation for providing individual discounts in response to an objective function, at least one input parameter, and at least one customer model,
where the modified simulated annealing operation has a deterministic selection of initial starting points.

7. The individual discount system according to claim 6, where the at least one customer model comprises one model for each customer.

8. The individual discount system according to claim 6, where the objective function comprises at least one of profits, sales volume, and customer satisfaction.

9. An individual discount system for optimizing retail store performance, comprising:
a modified simulated annealing operation for providing individual discounts in response to an objective function, at least one input parameter, and at least one customer model,
where the modified simulated annealing operation has a weighted selection of next generation starting points.

10. The individual discount system according to claim 9, where the at least one customer model comprises one model for each customer.

11. The individual discount system according to claim 9, where the objective function comprises at least one of profits, sales volume, and customer satisfaction.

12. A method for optimizing retail store performance with individual discounts comprising:
selecting input parameters;
dividing a search space in response to the input parameters;
generating initial starting points in the search space;
selecting a random neighbor for each initial starting point;
evaluating an average fitness of the initial starting points; and
generating new starting points in response to the average fitness.

13. The method for optimizing retail store performance according to claim 12, further comprising selecting a start temperature, a temperature reduction rate, and a cooling temperature.

14. The method for optimizing retail store performance according to claim 13, further comprising:
setting an operating temperature to be equal to the starting temperature;
setting a new operating temperature in response to the operating temperature and the temperature reduction rate; and
returning a solution where the new operating temperature is less than or equal to the cooling temperature.

15. The method for optimizing retail store performance according to claim 12, further comprising:
selecting a number of subpopulations and subpopulation size;
dividing the search space into subpopulations; and
for each subpopulation, generating initial starting points randomly.

16. The method of optimizing retail store performance according to claim 12, further comprising:
comparing objective function values of an initial starting point and a random neighbor;
if the difference between the objective function values of the random neighbor and initial starting point is greater than or equal to zero, setting the starting point to the random neighbor; and
if the difference between the objective function values of the initial starting point is less than zero, setting the starting point to the random neighbor in response to a probability.

17. The method of optimizing retail store performance according to claim 12, wherein the input parameters are selected from the group consisting of a number of subpopulations, a subpopulation size, a starting temperature, a temperature reduction rate, and a cooling temperature.

18. The method of optimizing retail store performance according to claim 12, further comprising:
eliminating initial starting points having fitness values below the average fitness; and
replacing eliminated starting points with starting points having fitness values above the average fitness values.
